(19) United States
(12) Patent Application Publication
(10) Pub. No.: US 2015/0336545 A1
(43) Pub. Date: Nov. 26, 2015

(54) MULTI-VALET TOOL

(71) Applicant: Anthony Leo Klein, Freeport, NY (US)

(72) Inventor: Anthony Leo Klein, Freeport, NY (US)

(21) Appl. No.: 14/630,391

(22) Filed: Feb. 24, 2015

Related U.S. Application Data
(60) Provisional application No. 61/944,003, filed on Feb. 24, 2014.

(51) Int. Cl. B60S 3/04

(52) U.S. Cl. CPC B60S 3/044; B60S 3/047

(57) ABSTRACT

A multi-purpose tool can perform a first task, such as washing a car with a car wash brush, scraping ice from a car with an ice scraper, or removing snow from a car with a snow remover, and a second task of delivering a fluid, such as car wash or de-icer, to a location adjacent to the tool performing the first task. For example, the multi-purpose tool can include interchangeable heads, one head having a car wash brush, and one head having an ice scraper. A liquid delivery tool can deliver a liquid next to the interchangeable head. This liquid can be car wash, car wax, de-icer, or the like. The multi-purpose tool can eliminate the need to keep a separate fluid delivery bottle and a wand tool.

### CROSS-REFERENCE TO RELATED APPLICATION

This application claims the benefit of priority of U.S. provisional application No. 61/944,003, the contents of which are herein incorporated by reference.

### BACKGROUND OF THE INVENTION

The present invention relates to hand tools and, more particularly, to a tool having a solution sprayer with multiple attachments disposed adjacent to a spray solution release nozzle.

Many times, a user needs to dispense a liquid while using another hand tool to disperse or spread the liquid. For example, to help clean a car, a user may apply soap and/or wax to the car and they need to spread the soap or wax about the car with a car cleaning brush or rag. Another example may be when a user applies an anti-ice spray on a car and then uses an ice scraper to remove the loosened ice.

In both of the above examples, the user needs to access two separate items to achieve the task. This can take additional time and require additional items to complete the task.

As can be seen, there is a need for a tool that can deliver a solution as well as perform additional necessary tasks, such as spreading the solution or scraping ice.

### SUMMARY OF THE INVENTION

In one aspect of the present invention, a multi-purpose tool comprises a wand having a first end and a second end; a connector disposed on the second end of the wand; one or more interchangeable heads configured to attach to the connector; and a fluid delivery system for delivering a liquid from a reservoir integral with the wand.

In another aspect of the present invention, a multi-purpose tool comprises a wand having a first end and a second end; a connector disposed on the second end of the wand; one or more interchangeable heads configured to attach to the connector; a fluid delivery system for delivering a liquid from a reservoir integral with the wand; a spray nozzle disposed adjacent the one or more interchangeable heads, the spray nozzle delivering the liquid from the reservoir to a location usable by the one or more interchangeable head; and a fluid delivery tube configured to carry the liquid from the reservoir to the spray nozzle, wherein the fluid deliver tube includes an inside tube and an outside tube, wherein the inside tube fits into and adjustably extends from the outside tube; and the wand has an adjustable length.

These and other features, aspects and advantages of the present invention will become better understood with reference to the following drawings, description and claims.

### BRIEF DESCRIPTION OF THE DRAWINGS

FIG. 1 is a side view of a multi-purpose fluid dispensing wand according to an exemplary embodiment of the present invention;

FIG. 2 is a perspective view of a snow removal/ice scraping tool, used with the wand of FIG. 1, according to an exemplary embodiment of the present invention;

FIG. 3 is a perspective view of a car wash brush, used with the wand of FIG. 1, according to an exemplary embodiment of the present invention; and

FIG. 4 is a perspective view of a general purpose brush, used with the wand of FIG. 1, according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a multi-purpose tool that can perform a first task, such as washing a car with a car wash brush, scraping ice from a car with an ice scraper, or removing snow from a car with a snow remover, and a second task of delivering a fluid, such as car wash or de-icer, to a location adjacent to the tool performing the first task. For example, the multi-purpose tool can include interchangeable heads, one head having a car wash brush, and one head having an ice scraper. A liquid delivery tool can deliver a liquid next to the interchangeable head. This liquid can be car wash, car wax, de-icer, or the like. The multi-purpose tool can eliminate the need to keep a separate fluid delivery bottle and a wand tool.

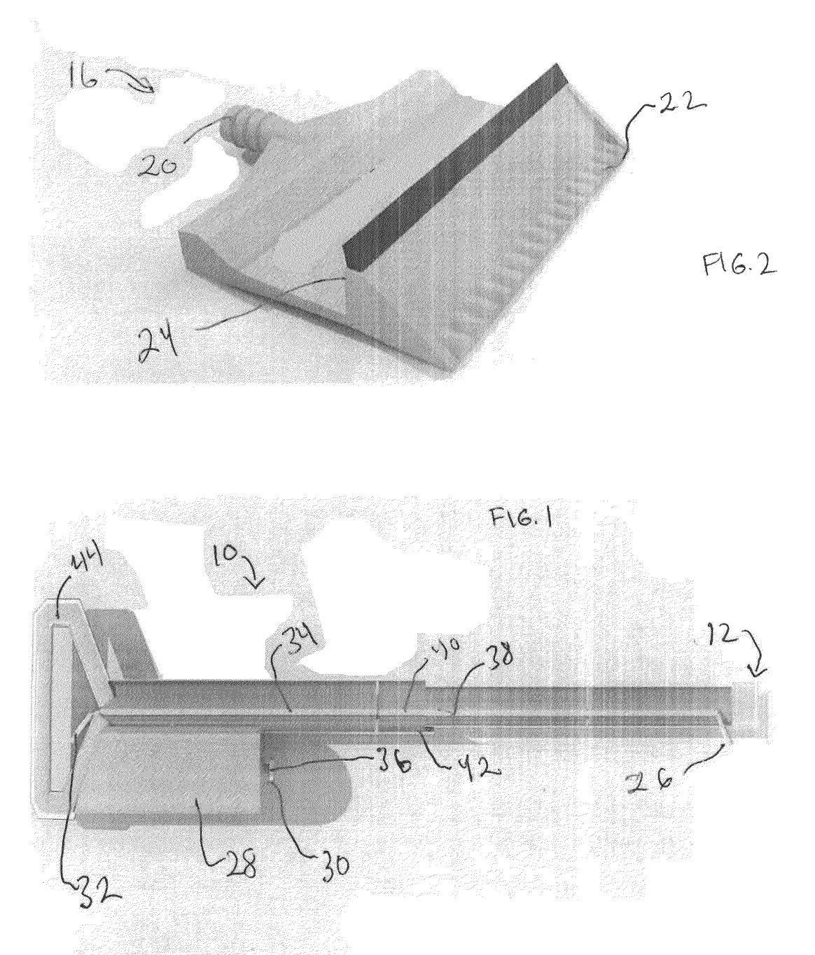

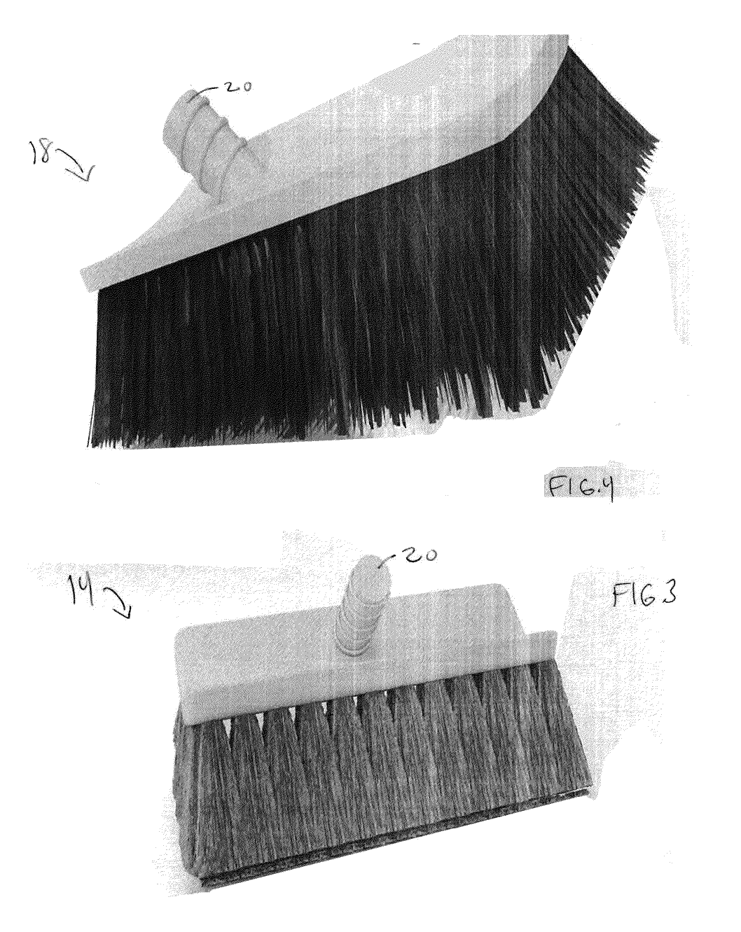

Referring now to FIGS. 1 through 4, a wand 10 can include a connection 12 for connecting a variety of heads, such as a car wash head 14 (FIG. 3), an ice scraping/snow removing head 16 (FIG. 2) or an general purpose brush head 18 (FIG. 4). The head 14, 16, 18 may be angled as may be desired for any particular application. For example, as shown in FIG. 3, the car wash head 14 may be angled for ease of use. Each of the heads 14, 16, 18 may have a mating connection 20 for mating with the connection 12 on the wand 10. While the figures show a male thread for the mating connection 20, mating with female threads in the connection 12 of the wand 10, other connections may be used within the scope of the present invention. For example, a quick disconnect, a press-on, a ball and dimple, or other type connection may be used to connect the heads 14, 16, 18 to the wand 10. Typically, as discussed below, the connection used to connect the heads 14, 16, 18 to the wand 10 will result in an orientation relative to the wand that is desirable for the intended use of the head. The wand 10 may include, opposite the connection 12, a handle 44, in various shapes, suited to assist a user in the use of the tool of the present invention.

The wand 10 can be made of various materials and may be coated, such as rubber coated, to help prevent damage to objects, such as a car, during use.

The ice scraper and snow remover head 16 may include an ice scraper 22 on one side and a snow remover 24 on the other side, as shown in FIG. 2. The snow removal side may be coated to prevent scratching of the vehicle. For example, a rubber coating may be disposed to allow a user to pull or push the snow off a vehicle.

Referring back to FIG. 1, a spray nozzle 26 may extend out of the wand 10 adjacent to the connection 12. The spray nozzle 26 may permit fluid to be delivered out of the spray nozzle 26 in a given direction. The head 14, 16, 18 can be designed to be aligned so that the spray nozzle 26 delivers fluid in a direction usable by the position of the head 14, 16, 18.

The liquid, as discussed above, may be car wash, car wax, de-icer, antifreeze, windshield cleaner, or the like. The liquid may be stored in a reservoir 28 located either in and/or adjacent to the wand 10. A fill cap 30 may be removably disposed on the reservoir 28 to allow filling thereof. A trigger 32, or some other activation mechanism, may be used to transfer fluid from the reservoir 28, through a fluid tube 34, and out the spray nozzle 26.

The fluid in the reservoir 28 may be pressurized to aid in delivery of the fluid out of the spray nozzle 26. In some embodiments, a hand pressure pump 36 may be disposed to pressurize the fluid in the reservoir 28. Other mechanisms may be used to help move the liquid from the reservoir 28 to the spray nozzle 26. For example, a battery powered pump may be provided in place of a hand pressure pump.

In some embodiments, the wand 10 may be extendable by telescoping the end, where an inner fluid tube 38 may extend from an outer tube 40. Various sealing mechanisms, such as O-rings, may be used to ensure that fluid does not leak from the union of the inner tube 38 with the outer tube 40. A locking mechanism 42, such as a locking sleeve, may be used to retain the wand 10 at a desired extended length.

It should be understood, of course, that the foregoing relates to exemplary embodiments of the invention and that modifications may be made without departing from the spirit and scope of the invention as set forth in the following claims.

What is claimed is:

1. A multi-purpose tool comprising:
a wand having a first end and a second end;
a connector disposed on the second end of the wand;
one or more interchangeable heads configured to attach to the connector;
a fluid delivery system for delivering a liquid from a reservoir integral with the wand.

2. The multi-purpose tool of claim 1, further comprising a spray nozzle disposed adjacent the one or more interchangeable heads, the spray nozzle delivering the liquid from the reservoir to a location usable by the one or more interchangeable heads.

3. The multi-purpose tool of claim 2, further comprising a trigger disposed to permit fluid to flow from the reservoir to the spray nozzle.

4. The multi-purpose tool of claim 1, further comprising a pressurization mechanism for pressurizing the liquid inside the reservoir.

5. The multi-purpose tool of claim 1, further comprising a fluid delivery tube configured to carry the liquid from the reservoir to the spray nozzle.

6. The multi-purpose tool of claim 5, wherein the fluid deliver tube includes an inside tube and an outside tube, wherein the inside tube fits into and adjustably extends from the outside tube.

7. The multi-purpose tool of claim 1, wherein the wand has an adjustable length.

8. The multi-purpose tool of claim 1, wherein the one or more interchangeable heads are removably attachable to the wand.

9. A multi-purpose tool comprising:
a wand having a first end and a second end;
a connector disposed on the second end of the wand;
one or more interchangeable heads configured to attach to the connector;
a fluid delivery system for delivering a liquid from a reservoir integral with the wand;
a spray nozzle disposed adjacent the one or more interchangeable heads, the spray nozzle delivering the liquid from the reservoir to a location usable by the one or more interchangeable head; and
a fluid delivery tube configured to carry the liquid from the reservoir to the spray nozzle, wherein
the fluid deliver tube includes an inside tube and an outside tube, wherein the inside tube fits into and adjustably extends from the outside tube; and
the wand has an adjustable length.

10. The multi-purpose tool of claim 9, further comprising a trigger disposed to permit fluid to flow from the reservoir to the spray nozzle.

11. The multi-purpose tool of claim 9, further comprising a pressurization mechanism for pressurizing the liquid inside the reservoir.
